(19) United States
(12) Patent Application Publication
(10) Pub. No.: US 2001/0010166 A1
(43) Pub. Date: Aug. 2, 2001

(54) Override mechanism for unlatching an electronic door lock

(76) Inventors: Christian Doucet, St-Bruno (CA); Pierre Doyon, Ile Bizard (CA)

Correspondence Address: SWABEY OGILVY RENAULT, SUITE 1600, 1981 MCGILL COLLEGE AVENUE, MONTREAL, QC, H3A2Y3, CA

(21) Appl. No.: 09/774,045

(22) Filed: Jan. 31, 2001

(30) Foreign Application Priority Data
Jan. 31, 2000 (CA) 2,297,854

(51) Int. Cl. E05B 47/00

(52) U.S. Cl. 70/279.1

(57) ABSTRACT

The present invention relates to electronic door locks, and more particularly to an override mechanism for unlatching an electronic door mortise lock from an electronically controlled locked side when it cannot be unlocked electronically. The override mechanism comprises an interior drive mechanism connected to a door handle input hub of the unlocked side, for driving the door handle input hub from a closed position to an open position, and a locking mechanism adapted to actuate the interior drive mechanism.

### BACKGROUND OF THE INVENTION

1. Field of the Invention

The present invention relates to electronic door locks, and more particularly to an override mechanism for unlatching or opening an electronic door mortise lock from an electronically controlled locked side in instances when the electronic door lock cannot or should not be unlocked electronically.

2. Description of Prior Art

Electronic door mortise locks having an electronically controlled locked door side and an unlocked door side are generally used to lock doors of hotel rooms and the like. Such door locks generally comprise a lever handle on the locked door side which remains locked and a lever handle on the unlocked door side which remains unlocked. An electronic mechanism such as a magnetic card reader is generally mounted to the locked door side such that a user having access to a magnetic card programmed to be recognized by the magnetic card reader can unlatch the lock from the locked door side. Such a mechanism is often powered by a battery connected thereto and is not accessible from the locked door side, for safety reasons.

A problem with such electronic door locks occurs when the battery goes dead or when the electronic mechanism becomes defective. In such cases, the electronic door lock fails to operate and the lock cannot be unlatched, preventing the door from being opened.

### SUMMARY OF THE INVENTION

One aim of the present invention is to provide an override mechanism which unlatches such an electronic door mortise lock from the electronically controlled locked side and which does not require modifications to the integrity of the lock.

In accordance with a broad aspect of the present invention, there is provided in an electronic door mortise lock having an electronically controlled locked side and an unlocked side, an override mechanism for unlatching the electronic door mortise lock from the electronically controlled locked side. The override mechanism comprises an interior drive mechanism connected to a door handle input hub of the unlocked side for driving the door handle input hub from a closed position to an open position and a locking mechanism accessible from said electronically controlled locked side and adapted to actuate the interior drive mechanism.

The locking mechanism may comprise an exterior drive mechanism connected to the interior drive mechanism for mechanically driving the interior drive mechanism from the electronically controlled locked side, and actuation of the exterior drive mechanism actuates the interior drive mechanism and drives the door handle input hub from the closed position to the open position, thereby unlatching the electronic door mortise lock from the electronically controlled locked side.

The exterior drive mechanism may comprise a cylinder lock connected to a tailpiece, and the locking mechanism may comprise a key.

The interior drive mechanism may comprise a gear mechanism having a spur gear connected to the tailpiece and a rotatable rack member connected to the lever handle input hub, and the gear mechanism may provide a gear ratio between the cylinder lock and the input hub of at least 3:1, and preferably of at least 5:1.

The cylinder lock and spur gear may rotate less than one turn to unlatch the door lock. The spur gear may be free to rotate without the tailpiece when the door handle is turned from the inside, and the tailpiece may drive the spur gear when the cylinder lock is rotated.

The gear mechanism may comprise a geared portion of a stop plate connected to a lever handle of the unlocked side.

The override mechanism may further comprise a detector for detecting actuation of the interior drive mechanism and an output for connecting the detector to the electronic door lock. Such a detector may comprise a cam connected to the tailpiece and having an outside rim, and a switch disposed adjacent the cam such that the switch is activated when the tailpiece is actuated, whereby when the cam is rotated with the tailpiece, the outside rim contacts the switch, thereby generating a signal indicative of actuation of the interior drive mechanism.

The interior drive mechanism may comprise a gear mechanism comprising a spur gear engaged with a geared portion of a lever handle stop plate connected to the lever handle input hub.

The override mechanism of the present invention allows a user having privileged access to unlock the electronic door mortise lock from the electronically controlled unlocked door side when the electronic door mortise lock is unlockable electronically, such as when electronic components thereof fail to operate or when the battery goes dead.

### BRIEF DESCRIPTION OF THE DRAWINGS

Having thus generally described the nature of the invention, reference will now be made to the accompanying drawings, showing by way of illustration a preferred embodiment thereof, in which like numerals refer to like components, and in which:

FIG. 1 is a side view of an electronic door mortise lock mounted to a door and comprising an embodiment of an override mechanism in accordance with the present invention, showing in housingly breakaway view internal components thereof;

FIG. 2 is a plan view of the inside housing of the housing of the electronic door mortise lock and showing the override mechanism in accordance with the present invention;

FIG. 3 is a front perspective view of a spur gear of the embodiment of the override mechanism shown in FIG. 2; and

FIG. 4 is a rear perspective view of a cam of the embodiment of the override mechanism shown in FIG. 2.

### DETAILED DESCRIPTION OF THE INVENTION

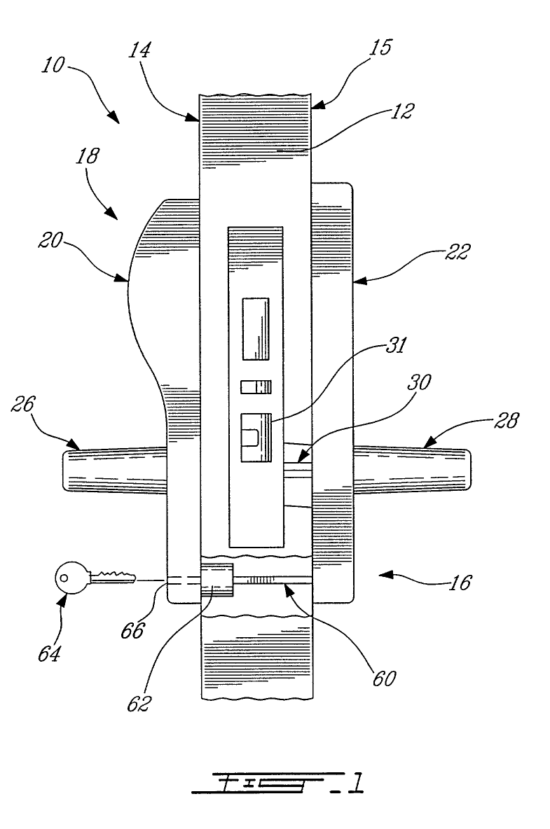

Referring now to FIG. 1, there is provided an electronic lock 10 for insertion in a mortise of a door 12 having an exterior door side 14 and an interior door side 15 and for electronically controlling the locking of the exterior door side 14, while leaving the interior door side 15 unlocked. The electronic lock 10 comprises an override mechanism 16 in accordance with the present invention.

The electronic lock 10 has a housing assembly 18 including an outside housing 20 mounted to the exterior door side 14 and an inside housing 22 mounted to the interior door side 15. An outside lever handle 26 outwardly extending from the outside housing 20 and an inside lever handle 28 outwardly extending from the inside housing 22 are mounted to opposed ends of a square spindle 30 extending through the mortise of the door 12 and which is connected to a retractable latch bolt 31. As mentioned above, the inside housing 22 remains unlocked so that when the inside lever handle 28 is rotated, the square spindle 30 rotates from a closed position to an open position and the latch bolt 31 is retracted inside the mortise of the door 12 from a closed position to an open position.

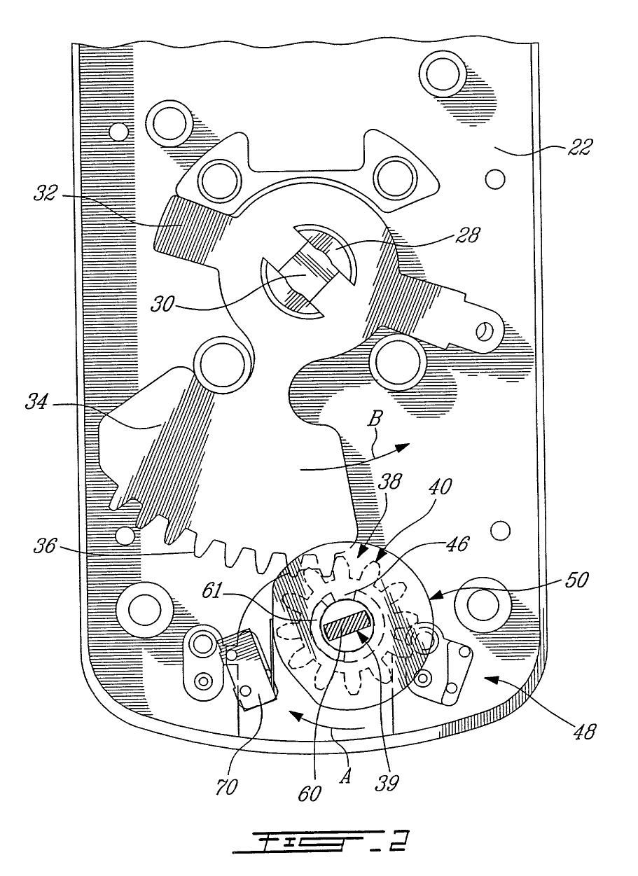

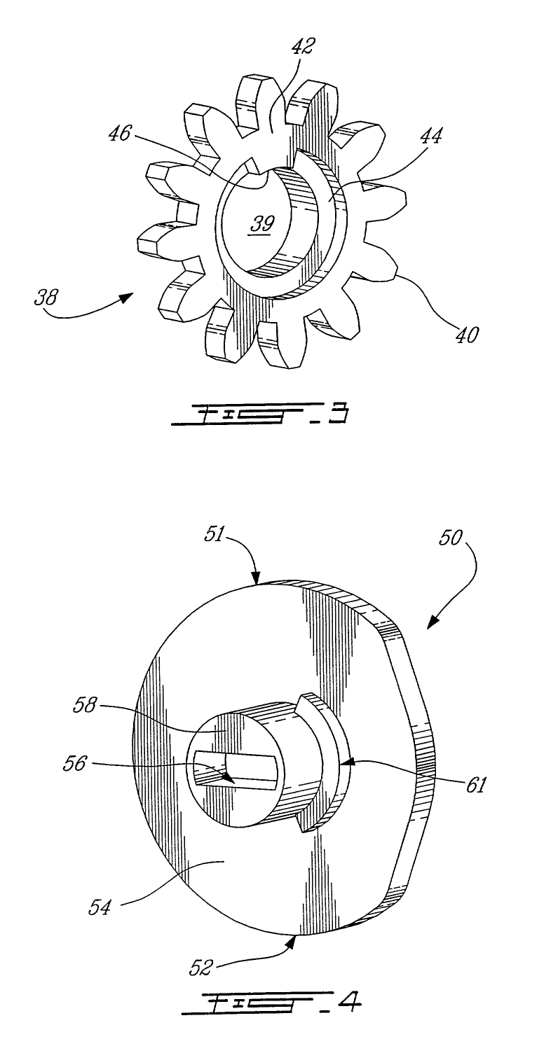

As shown in FIG. 2, a lever stop plate 32 is mounted to the square spindle 30 and connected to the inside lever handle 28. The lever stop plate 32 has a curved rack 34 with eight teeth 36. A circular spur gear 38 has an opening 39 at the center thereof and twelve spaced apart spurs 40 outwardly extending with respect to an axis going through the opening 39. The spur gear 38 has its spurs 40 meshed with the teeth 36 of the curved rack 34. Rotation of the spur gear 38 in the direction indicated by the arrow A moves the lever stop plate 32 from the closed position shown in FIG. 2 to an open position in the direction shown by the arrow B. As shown in FIG. 3, the spur gear 38 has a front surface 42 which defines an annular recess 44 about the opening 39. An abutment 46 extends radially inwardly in the recess 44 for purposes to be later explained. As seen in FIG. 2, the opening 39 of the spur gear 38 receives a tailpiece 60 extending from a rotatable cylinder lock 62 (FIG. 1) for movement therewith. The cylinder lock 62 is actuatable with a key 64 (FIG. 1) insertable through an opening 66 in the outside housing 20. The key rotates ⅔ of a turn for retracting the latch bolt 31. The cylinder lock 62 may be a 6-pin “key-in-knob” such as the cylinder lock from Lori Lock and Rocky Mount, and the key 64 may be a Lockwood 1004 reverse. Mushroom pins (not shown) may be used for at least three pins for increased safety. The torque required on the key 64 will not exceed 9 in-lbs when the latch bolt 31 is projected or when the required torque on the inside lever is 50 in-lbs or less because of warped doors. The cylinder lock 62 may be incorporated in the die of the outside housing 20. A medallion (not shown) can be used to cover the opening 66 for the keyway.

The override mechanism 16 is operated when the key 64 is inserted in the opening 66 in the outside housing 20. Rotation of the key 64 is transmitted to the tailpiece 60 rigidly connected to the cylinder lock 62 and rotates the spur gear 38, which moves the inside lever stop plate 32 from the closed position as shown in FIG. 2 to the open position as indicated by the arrow B. This causes the latch bolt 31 to retract inside the mortise of the door 12.

A detector 48 is included for detecting the actuation of the spur gear 38. The detector 48 comprises a cam 50 drivingly connected to the tailpiece 60 and having an outside rim 51. As shown in FIG. 4, the cam 50 has a front surface 52 and a back surface 54 defining a rectangular slot opening 56 at the center thereof for receiving the tailpiece 60 so that a torque can be transferred from the tailpiece 60 to the cam 50. The back surface 54 thereof is disposed adjacent the front surface 42 of the spur gear 38. The back surface 54 of the cam 50 defines a circular projection 58 outwardly extending from the plan of the back surface 54. An abutment 61 projects outwardly from the circular projection 58 with respect to an axis going through the slot opening 56. As shown in FIG. 2, the abutment 61 is received in the recess 44 on one side of the abutment 46. When a key is inserted into the cylinder lock 62 and rotated in a clockwise direction, as indicated by arrow A, the tailpiece 60 will rotate the cam 50 in the same direction, thereby causing the abutment 61 to push on the abutment 46. This will cause the spur gear 38 and, thus, the stop plate 32 to rotate with the cam 50. The movement communicated to the stop plate 32 will cause the inside lever handle 20 to rotate to retract the latch bolt 31. However, when the inside lever handle 28 is operated to displace the latch bolt 31 to an open position, the induced counter clockwise rotation of the stop plate 32 will cause the spur gear 38 to rotate in a clockwise direction, thereby displacing the abutment 46 away from the abutment 61 of the cam 50. Therefore, no motion will be communicated to the cam 50.

It is understood that once the override mechanism 16 has been actuated to retract the latch bolt 31, a biasing force acting, for instance, on the stop plate 32 will bring back the spur gear 38 to its rest position (FIG. 2), thereby causing the abutment 46 to push on the abutment 61 so as to cause the cam 50 to return to its idle position (FIG. 2).

A switch 70 is disposed adjacent the outside rim 51 of the cam 50. An output (not shown) is connected to the switch 70 for connecting to the electronic door lock 10. When the cam 50 is rotated by the tailpiece 60 from its idle position to an operative position, the outside rim 51 or cam surface thereof will trigger the switch 70, thereby generating a signal indicative of actuation of the override mechanism 16. Alternatively, the tailpiece 60 can be directly drivingly connected to the spur gear 38 if the detector 48 is not needed.

While the invention has been described with particular reference to the illustrated embodiment, it will be understood that numerous modifications thereto will appear to those skilled in the art. Accordingly, the above description and accompanying drawings should be taken as illustrative of the invention and not in a limiting sense.

What is claimed is:

1. In an electronic door mortise lock having an electronically controlled locked side and an unlocked side, an override mechanism for unlatching said electronic door mortise lock from said electronically controlled locked side, said override mechanism comprising:
an interior drive mechanism connected to a door handle input hub of said unlocked side, for driving said door handle input hub from a closed position to an open position; and
a locking mechanism accessible from said electronically controlled locked side and adapted to actuate said interior drive mechanism.

2. An override mechanism according to claim 1, wherein said locking mechanism comprises an exterior drive mechanism connected to said interior drive mechanism for mechanically driving said interior drive mechanism from said electronically controlled locked side,
whereby actuation of said exterior drive mechanism actuates said interior drive mechanism and drives said door handle input hub from said closed position to said open position, thereby unlatching said electronic door mortise lock from said electronically controlled locked side.

3. An override mechanism according to claim 2, wherein said exterior drive mechanism comprises a cylinder lock connected to a tailpiece for driving said interior drive mechanism.

4. An override mechanism according to claim 1, wherein said interior drive mechanism comprises a gear mechanism having a gear drivingly connected to said locking mechanism and a rotatable rack member connected to said lever handle input hub, and in meshing engagement with said gear.

5. An override mechanism according to claim 4, wherein said gear mechanism provides a gear ratio between said cylinder lock and said input hub of at least 3:1.

6. An override mechanism according to claim 5, wherein said gear ratio is of at least 5:1.

7. An override mechanism according to claim 4, wherein said gear rotates less than one turn to unlatch said door lock, said gear being free to rotate without said locking mechanism when said door handle is turned from the unlocked side, while being drivable thereby when said locking mechanism is actuated.

8. An override mechanism according to claim 7, wherein said gear mechanism comprises a geared portion of a stop plate connected to a lever handle of said unlocked side, said geared portion meshing with said gear.

9. An override mechanism according to claim 1, further comprising a detector for detecting actuation of said interior drive mechanism and an output for connecting said detector to said electronic door lock.

10. An override mechanism according to claim 7, further comprising a detector for detecting actuation of said interior drive mechanism and an output for connecting said detector to said electronic door lock.

11. An override mechanism according to claim 10, wherein said detector comprises a cam drivingly connected to said locking mechanism for transmitting a torque from said locking mechanism to said gear, said cam having a cam surface adapted to engage a switch when said cam is rotated by said locking mechanism, thereby generating a signal indicative of actuation of said interior drive mechanism.

12. An override mechanism as defined in claim 11, wherein a torque transferring means is provided between said cam and said gear for allowing said cam to rotate said gear, while allowing said gear to rotate independently of said cam when a door handle of the door mortise lock is operated from the unlocked side.

13. An override mechanism as defined in claim 12, wherein said torque transferring means include an abutment extending from said cam for engagement with a corresponding abutment on said gear.
